(19) United States
(12) Patent Application Publication
(10) Pub. No.: US 2003/0168552 A1
(43) Pub. Date: Sep. 11, 2003

(54) Aircraft propulsion system and method

(76) Inventor: Paul Anthony Brown, Ft. Lauderdale, FL (US)

Correspondence Address: Paul Brown, # 109, 5557 WEST OAKLAND PARK BOULEVARD, FT LAUDERDALE, FL, 33313, US

(21) Appl. No.: 10/091,273

(22) Filed: Mar. 5, 2002

(51) Int. Cl. B64D 27/00

(52) U.S. Cl. 244/55

(57) ABSTRACT

The invention concerns an aircraft propulsion system involving propellers, where two propellers are overlapped partially and staggered so that they do not strike each other in a complete range of motion. Two engines that are mounted on to the same fuselage power each propeller.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

This invention relates to aircraft, and more particularly to the field of propeller arrangement, a new means of propulsion.

Sep. 11, 2001 terrorist attacks has prompted the sudden demand for improvements in the aviation transportation system to deter a repeat of this incidence. This occurred at a time when aviation was under increasing demand to provide a plan to satisfy the rapid growth of commuters. It would be understandable since the terrorist acts where unexpected that prior plans be revised accordingly. It's important that the plans implemented not conflict, as this represents a waste of time and resources. Conflicting plans such as the implementation of NASA small aircraft transportation system (SATS) versus plans to incorporate larger aircrafts such as NASA blended wing body aircraft. Both would require substantial changes to airports. Another plan also is the civil tilt rotor (CTR), which would be inline with the SATS system as they both involve small aircrafts. All are government plans which contradicting indicates confusion. First I will summarize the major reasons why a conflict occurs in the contrasting plans and also the advantages in regards to counter terrorism. Then I will introduce general aviation propulsion (GAP) as the basis for current limitation of the role of small aircrafts and how the problems where approached in prior art. Why propellers and the environment. Concluding with military applications.

Provisional theory was based on wake turbulence, for the 1^{st} airline crash prior to September 11^{th}, and was accompanied by admission of little knowledge about the same. This much is understood the larger the aircraft the more powerful the wake turbulence. The justification of building larger runways to accommodate larger aircrafts without proper knowledge of their effect on current airlines or smaller civil aircraft is a conflict. Additionally a larger aircraft is also a larger guided missile. Jan. 5, 2002 a small aircraft piloted by an American suicide pilot flies into a bank of America building. The fact remains the inadequacy of aviation security. It's no comfort that these teenagers are the pilots of tomorrow. The crash also proved small aircrafts are not effective weapons of mass destruction. As much damage can be done with a car as a small aircraft, and everyone wont prefer taking the bus. The object is faster commuter destination to destination. With a personal small aircraft (PSA) an individual would be able to land at his neighborhood airstrip eliminating road congestions also. Considering the time in transit to international airport and from, and security related delays. A PSA would not have to be faster than a commercial airline to get commuters to their destination faster.

The relation of GAP to the limitations of small aircraft role is the inadequacy of multi-engine and single engine problems. Multi-engine is synonymous with safety for commercial airlines, however this does not translate for small aircrafts. The reduced power to weight ratio of current engines available for small aircraft, is not sufficient to power an aircraft with a single engine working. To overcome the asymmetric thrust induced by engines being so far apart from the center of gravity. A fully deflected rudder to compensate for side drift, its obvious why the aircraft loses forward speed and climb ability. If you mishandle the situation, your chance of getting into a fatal spin is much greater than it would be in a single. Add also single engine problems including slipstream problems where involuntary rudder deflection makes flight unduly complicated even in perfect weather. In the event of engine failure and you are negotiating an emergency non-powered landing the aircraft losses yaw control stability, because the rudder was canted to be inline with propeller slipstream at cruise.

Propeller powered canard pushers and flying wing concepts, have a limitation, making twin-engine not very practical. Mainly limits to the area available for flaps and aileron and a very narrow center of gravity (CG) tolerance. Small amphibians flying boats are another aircraft where wing mounted twin engines are not practical. As there is a need to shield engine from water spray, this limits the aircraft to a single engine, as the fuselage provides a shield. If twin engine the nacelle is mounted too high above fuselage, this inefficient thrust line is typical of most amphibians. Other small aircraft problems not specific to amphibians regarding engines mounted on the wings of an aircraft, is the inability to make Practical folding or removable wing option. This ability is the one small step to a road-able aircraft which benefits to PSA cannot be understated.

Inline twin-engine aircrafts have fewer problems but again with a central located pusher and tractor propeller on both ends of the fuselage. Results in a large resultant power difference due to the varying moment caused by distances from CG. An aircraft must be properly balanced and optimized around the center of gravity and as such there is always a bias when propulsion forces are at large distances apart, unfortunately flight dynamics is not symmetrical around the center of gravity. Meaning that there will always be a bias to one engine or at best both engines will be similarly, inefficiently located and disadvantaged. The result will always be a substantial change in the flight handling characteristics of the aircraft with one engine inactive, not attributed with expected loss of power.

The final prior art to be discussed is the CTR, hybrid between the vertical takeoff and landing (VTOL) of a helicopter with compromise of speed of a fixed wing aircraft. The complexity and operational costs of a helicopter is not solved but increased with a CTR the main advantage is speed over a helicopter. I will also add ducted fan VTOL aircraft to the CTR category, currently developed for use in “flying car” concepts. Futuristic plans based on theory rather than facts. Fact is military tilt rotor program has come under scrutiny after several unprovoked fatal accidents. A hybrid propeller used as both a rotor and propeller is no good as either. Emergency options are limited unlike a helicopter there is no auto-rotation and ballistic parachute is only an option for particular gross weight, speed and altitude. What must be understood is that tilt-rotors do not operate efficiently in VTOL mode but takeoff preferably with a tilt, STOL mode. Considering STOL mode is comparable with small fixed wing aircrafts ideal for a PSA, the advantages are limited if the problems faced by current light fixed wing aircraft are solved. Coexistence of CTR and PSA on runways less than 1000 ft is a possibility.

Why propellers considering jet propulsion, it must be realized that jet propulsion is based on the use of propeller (fans) and that any technology developed could be beneficial to both. The main difference is that jet propulsion always utilizes the combustion of raw fuel, while propellers can utilize solar, battery and other auxiliary power sources. The destruction of the ozone layer by highflying aircraft is probably underestimated due to ignorance, but is a serious issue. The reduction of automobile traffic and related pollution by implementing PSA is also desired. Other pollution reduced is noise. Propeller propulsion is more energy efficient than jet propulsion. And finally amphibious advantage, jet engines flame out if small amounts of water get into the engine.

The military abandoned propeller propulsion advancement for jet propulsion because of speed. Efforts to improve the speed of propeller driven aircraft focused on increasing the horsepower of the engines without little regard for the propellers themselves. The propellers create drag as well as thrust. A high-speed propeller should be of interest to the military for use in an amphibious aircraft. Other application such as unmanned aerial surveillance vehicles would also benefit from a quieter propulsion (stealth) system that could utilize environmental and electrical energy to prolong loiter time indefinitely. A backup reconnaissance system is needed in the event of star wars. It is beyond the scope of this application to go into any more detail.

### BRIEF SUMMARY OF THE INVENTION

Counter-terrorism objective is sought by the implementation of this invention to improve the safety, reliability and simplicity of operation of small aircraft as means of common everyday transport. Where aviation security will be aided by giving individuals the freedom they now have in automobiles in the air. Reducing security related delays and frustrations in regards to commercial aircraft without compromise to national security. Providing solutions to the safety and reliability issues limiting the role of the small aircraft mainly asymmetric thrust and slipstream. Based on the anticipated implementation of SATS, this propulsion system allows new aircraft designs focused on creating a road-able aircraft, the use of folding or removable wings. The allowance of twin-engine option where only single engine was practical, additionally the present objective is to provide a propeller system capable of outperforming traditional propellers in top end speed. A high thrust low drag propeller system and aircraft. Fuselage drag reduction is achieved by shielding nacelles substantially behind the fuselage, hence reducing drag. Its an objective to prove the viability of propellers as energy efficient environmentally friendly alternative to jet propulsion. Noise pollution advantage over jet propulsion is also a relevant objective.

The anticipation that the simplicity of this invention based on current proven technology, will not only guarantee success, but also reduce operational and maintenance costs and therefore accessibility to the general public. It is also my observation that engines are getting smaller, quieter, lighter and more efficient everyday and this is part of the role of the GAP program. It's also an objective to create an STOL aircraft capable of taking off from short remote runways reducing the stress on commercial airports and road congestion also, achieved mainly by limiting the gross weight of the aircraft by use of small aircrafts suitable for private use, PSA. Possible military applications are also hinted at.

### BRIEF DESCRIPTION OF THE SEVERAL VIEWS OF THE DRAWING

FIG. 1 is a perspective view of an amphibious aircraft adapted for use of the propulsion system, “rammer”.

FIG. 2 is a perspective view of a canard pusher aircraft adapted for use of the propulsion system, “hammer”.

FIG. 3 illustration of propeller airflow provides explanation of effectiveness based on Bernoulli's principle.

FIG. 4 is a perspective of propeller blade interaction, how it enhances the venturi.

FIG. 5 is a plan view of the propulsion system.

FIG. 6 is a plan view, comparable to FIG. 5, of prior art single engine setup.

FIGS. 7A-7B illustrates a comparison of desirable fuselage shapes, according to FIGS. 5 and 6.

FIGS. 8A-8C is front elevation of bi-propulsar, showing various positions of overlapped propeller and effect.

FIG. 9 is a schematic front elevation mainly depicting zones of variation of blade mach speed.

FIGS. 10A-10C is a schematic front elevation as FIG. 9, with further illumination of the partial angle of eclipse.

FIGS. 11A-11B is a cross-section of airfoils in warp zone, indicating airflow for both directions of rotation.

FIG. 12 is a side elevation of propeller blade, illustrating twist.

FIG. 13 is a cross-section of propeller blade, illustrating cahedral in the tip.

FIG. 14 is a plan-form of propeller blade, discussing profile and effectiveness as a bi-propulsar.

FIG. 15 is a diagram showing by comparison height and width advantage over prior art.

FIGS. 16A-16B is a perspective of helical contrail, showing relation between frequency and slipstream direction.

FIG. 17 is a plan view of contra-rotating contrails of bi-propulsar and twin rudder.

FIGS. 18A-18B is a plan showing canting of leading propeller towards trailing propeller, and anhedral coning of blade.

FIGS. 19A-19B is a perspective showing simplified discs and the benefit of coning.

FIG. 20 is a side elevation of a propeller in a bi-propulsar, providing miscellaneous options.

FIGS. 21A-21B is a side elevation showing two methods for effecting similar anhedral coning in propeller.

FIG. 22 is a front elevation showing swept propeller blades for controllable pitch and coning angle propeller.

FIG. 23 is a front elevation of bi-propulsar, further discussing swept propeller blade.

FIG. 24 is a perspective of contrail cylinder for contra-rotating bi-propulsar.

FIG. 25 is a perspective of contrail cylinder for similar-rotating bi-propulsar.

FIGS. 26A-26C is a cross-sections series of the “twister” as introduced in FIG. 23.

FIG. 27 is a perspective of helical spirals causing a twisting motion.

FIG. 28 is a front elevation of bi-propulsar showing leading propeller not interacting with static trailing propeller.

### DETAILED DESCRIPTION OF THE INVENTION

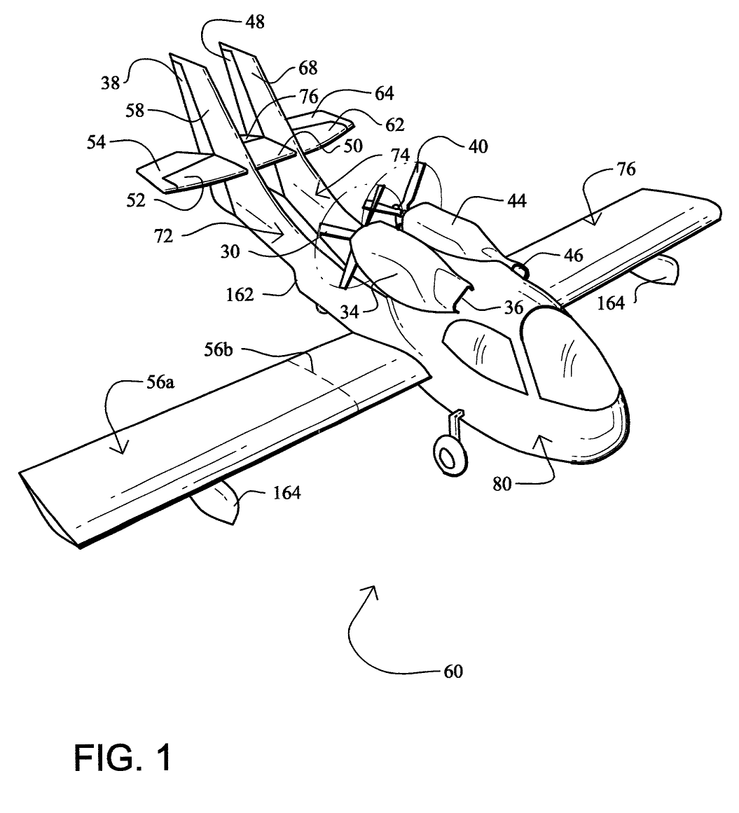

FIG. 1 is a perspective view of an amphibious aircraft adapted for use of the propulsion system. This system consists of a leading propeller 30 and trailing propeller 40. While propellers are offset relative to each other the left and right nacelle, 44 and 34 respectively, are relatively parallel. The same is applicable for the left and right air intake, 46 and 36 respectively. The propellers are partially shielded from the water spray by the left and right tail, 74 and 72 respectively. Both tails have a step 162 to break water tension hold on takeoff. Propellers are additionally shielded from water spray by the left and right wing, 76 and 56a respectively. STOL wings are desired effected by leading edge slats or simply by profile of airfoil. Both wings are possible to be separated from the fixed wing base attached to fuselage 80, separation point 56b is relatively symmetrical on both sides of the aircraft, and is less than or relatively equal to the width of the left and right elevators 54 and 64 respectively. With a central fuel tank and minimal fuel in the wings they will remain light and maneuverable by one person, even with sponsons 164 for buoyancy stability. While the wings will be easily foldable or removable for towing the elevators will be more fixed, defining the width of the tow-able aircraft. Left and a right horizontal stabilizer fin, 68 and 58 respectively, further divide the elevator creating a central elevator 76. Elevators are supported by a left, center and right vertical stabilizer fins, 62, 50 and 52 respectively. The elevator is relatively inline with center of propeller. The vertical stabilizer fins support the left and right rudders, 48 and 38 respectively, and the center is relatively inline with the propellers centerline. Both rudders remain relatively parallel to each other, and move together in the same direction. The entire amphibious aircraft modified for use of this propulsion system is referred to as “rammer” 60, for simplicity.

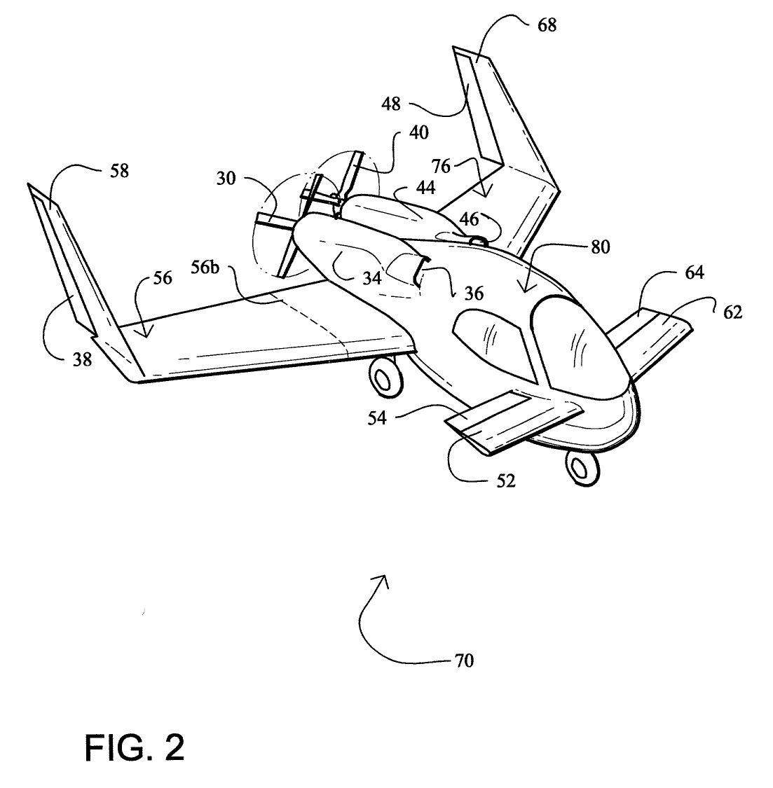

FIG. 2 is a perspective view of a canard pusher aircraft adapted for use of this propulsion system. Simplified name for entire configuration is “hammer” 70. The hammerhead likeness of the fuselage created by the forward mounted left and right vertical stabilizer, 62 and 52 respectively. Represents the main change in this configuration, as the propeller, nacelle and air intake remain similar to the “rammer”. As shown there is no longer a central elevator, and while the elevator is still higher than the wing and a twin rudder system remains, no stabilizer control surface interferes with the contrails of the propellers. See FIG. 1 for additional reference numerals relevant to FIG. 2. The more aerodynamic profile coupled with the tapered wing will enable higher speeds in this configuration over the prior “rammer”. The “hammer” configuration represents the preferred option for unmanned aerial surveillance vehicle. It should also be noted that between the two nacelles a window addition would provide even more visibility from the cockpit to a design where propellers do not interfere with the view. This is also applicable to “rammer.” The twin rudders being further apart afford greater roll stability in this configuration. And that similar to both configurations rudder is inline with direction of aircraft and not canted for airflow of propeller slipstream whether it interacts with contrail or not. Simplifying flight controls.

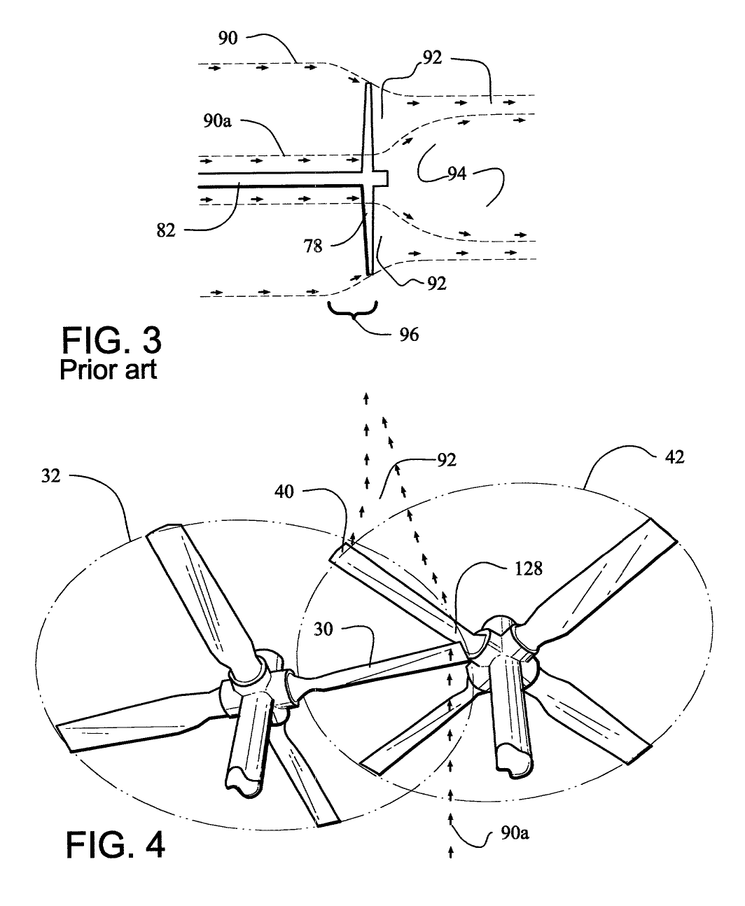

FIG. 3 illustration of propeller airflow, propellers work but why. The shape of a propeller is evident in nature as a seed from a particular tree. As the seed falls it breaks it own fall by creating upward thrust, it windmills as incoming air rotates it, the reason for this is attributed to the twist. Propellers are given a substantial twist see FIG. 13. The effectiveness of a propeller is dependent on three main factors

(a) The speed of the incoming air, free-stream, 90a-90b.

(b) The speed of rotation of the propeller blades.

(c) The speed of the outgoing air, contrails

Any of the above factors can induce all the others. In an aircraft with an engine this is induced by rotation of the propeller shaft 82 that transfers power to propeller from engine. Prior art comparison of pusher to tractor aircraft reveals the potential for pusher to be more efficient, this is attributed to the fact that a tractor aircraft spoils contrails of the propeller since nacelle is behind propeller direction of motion instead of in front of as in a pusher. This interferes with the creation of a high-pressure constriction, a venturi 92, in effect increasing velocity and speed of contrail according to Bernoulli's principle. A low-pressure zone 94 contributes to further constriction of the contrail. The constriction of the air is similar to the incoming air constriction due to the extended area of influence in front of the propeller, suction 96. Because the data between efficiency of tractor and pusher are close its conclusive that both are relatively important.

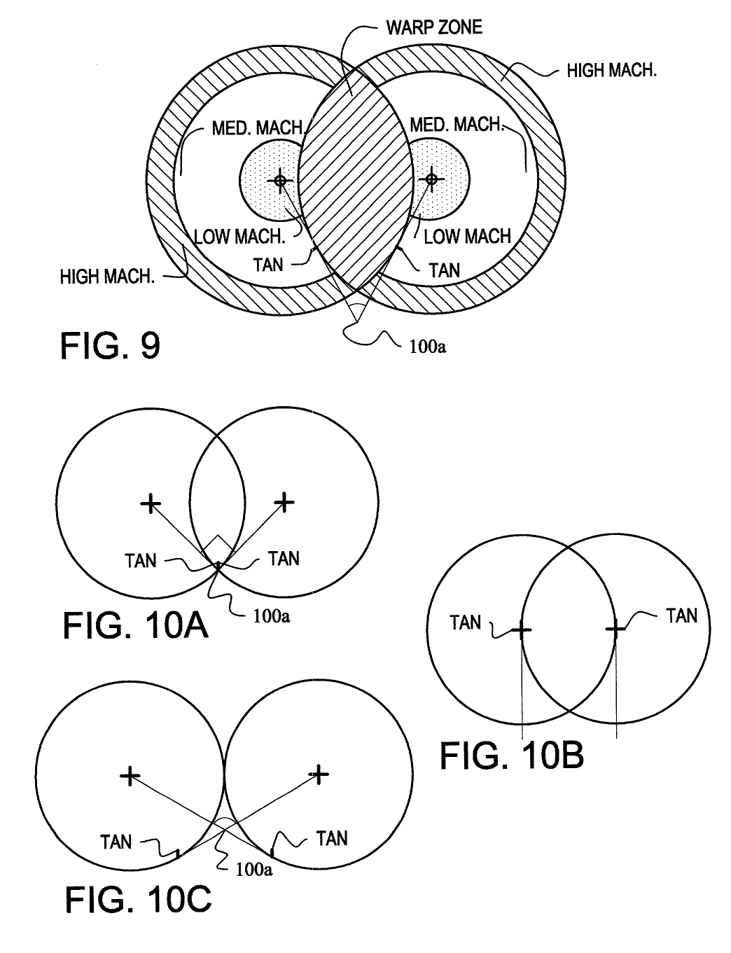

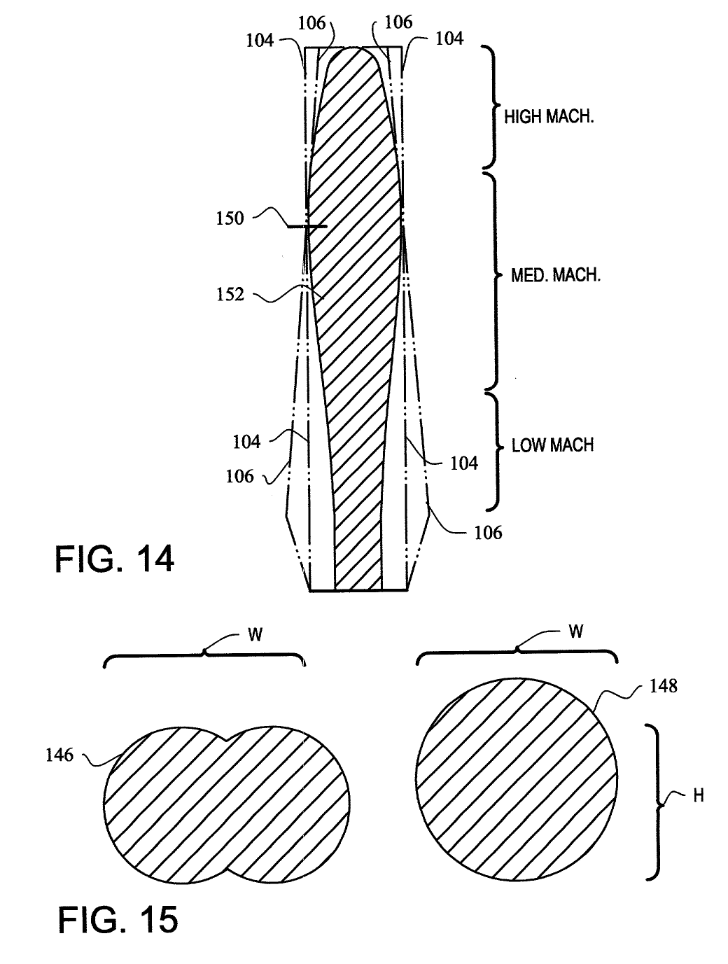

The twist is the major difference between a propeller and rotor due to variation in resultant vector of thrust induced by the substantial twist of a propeller and reduced diameter, this makes the propeller an unstable mean for hovering. And explains why a tilt-rotor which has a hybrid of a propeller and rotor called a propulsor, is not as effective for any task as it compromises both. A rotor has a uniform resultant vector and solves lift being uniform along a blade with varying mach speeds, (see FIG. 9 and FIG. 14) by varying the airfoil thickness and chord length.

FIG. 4 is a perspective of propeller blade interaction, how it enhances the venturi. Incoming air 90a is slowed by interaction with the nacelle of the aircraft. The leading propeller 30 provides increased power to the low mach area of the trailing propeller at, and hence induces a translation of power at point 128. The subsequent outgoing air is given more power and this enhances the venturi 92. This contributes to high thrust warp zone, (see FIG. 9.). 32 and 42 indicates range of motion of propellers and traces a circular disc. When a high mach area meets a low mach area its more efficient and produces less noise than a contra-rotating propeller where both propellers are on the same shaft one directly in front of the other. This results in poor efficiency and noise as high mach area shadow high mach area, while two medium mach zones may benefit by small increase in performance two low mach areas cannot amount to much, more like blind leading blind.

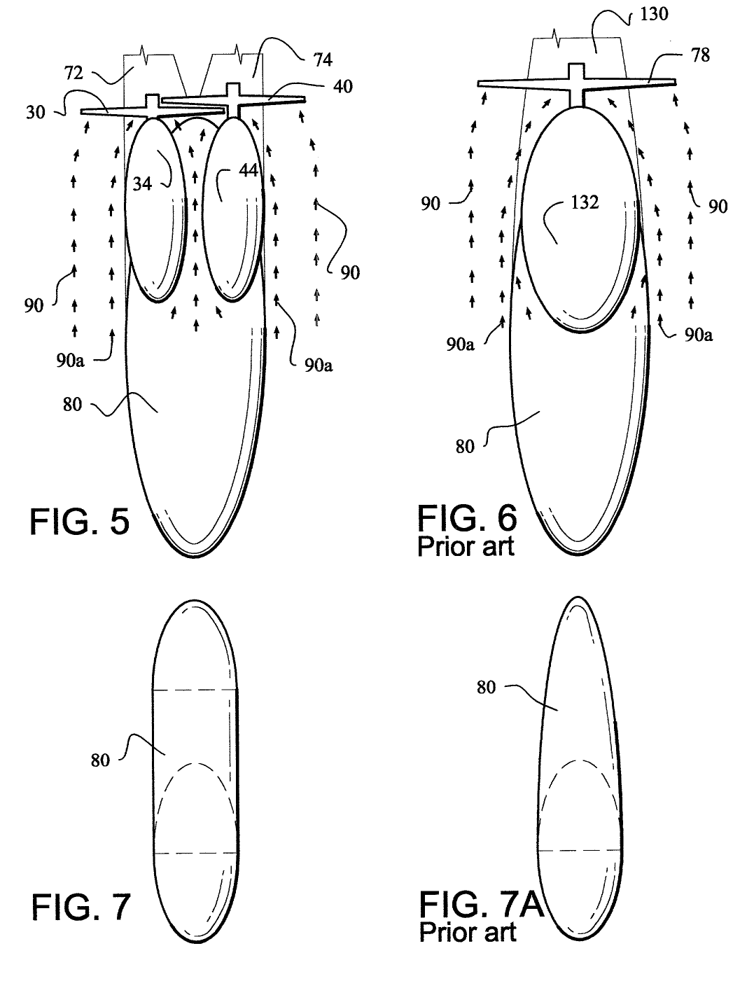

FIG. 5 is a plan view of the propulsion system, which consists of the leading propeller 30, and trailing propeller 40. The entire propeller system will from now on be referred to as bi-propulsar. The plan shows the fuselage 80 and the left nacelle 44 and right nacelle 34 being relatively symmetrical on the fuselage. The central airflow between nacelles 98 shows that both nacelles are separate. The twin tail 72 and 74 is shown alongside nacelle as being substantially shielded by fuselage from the incoming air. The twin tail merging to the fuselage is only applicable for the “hammer” configuration. Incoming air 90a has a more direct route to propeller in comparison to prior art see FIG. 6. The comparison is using two smaller inline engines of half the power of prior art where total area of bi-propulsar and conventional propeller is the same. The bi-propulsar will offer twin-engine reliability and more power. As can be seen if only the speed of the incoming air is considered, the bi-propulsar shows a more direct path of airflow and hence advantage.

FIG. 6 is a plan view, comparable to FIG. 5, of prior art single propeller 78 setup. Both setups are the same area (see FIG. 15) and total horsepower. However incoming air 90a has to bend much more around fuselage and this represents loss of power and drag. Even if the nacelle is mounted even higher than fuselage. The fuselage still can overshadow the propeller its dependent on direction of incoming air. In any case a more powerful engine is always larger and such also will be the size of the nacelle 132. Single tail 130, prior art.

FIGS. 7A-7B illustrates a comparison of desirable fuselage shapes, according to FIGS. 5 and 6 respectively. Cabin space has always been compromised in conventional aircraft fuselage 80. The prior art fuselage tapers to meet the tail as shown in FIG. 7B. While the bi-propulsar fuselage can utilize a wider fuselage shape FIG. 7A without the associated drag. Even if fuselage tapers in side view like 7B, this offers more room and a more comfortable cabin. Understanding that as this aircraft is a pusher the fuselage can truncate and does not necessarily need to be cylindrical to be efficient, as this originated to accommodate the rotating air from the propeller from creating turbulence against fuselage (fuselage stall).

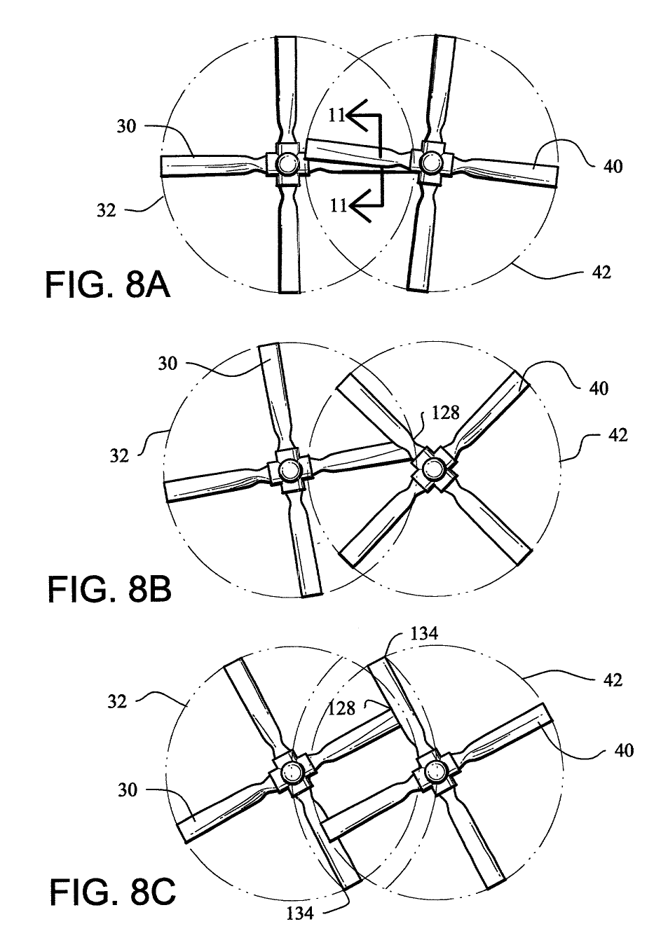

FIGS. 8A-8C is front elevation of bi-propulsar, showing various positions of overlapped propeller and effect. For simplicity it's assumed that both propeller are rotating at relatively the same speed.

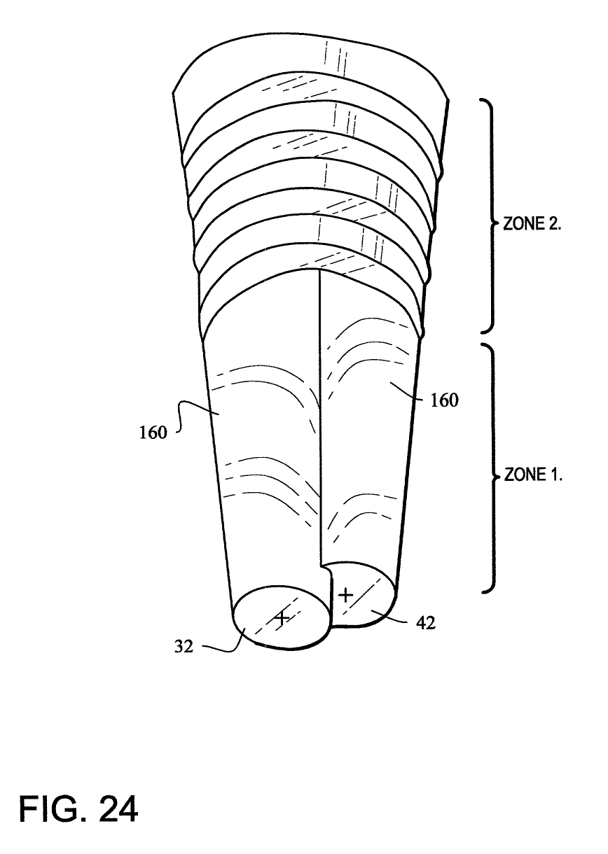

8A Leading propeller 30 and trailing propeller 40 are shown in synchronized positions that will allow both blade to cross and completely overshadow the wake of each other on each revolution. This is not the preferred interaction especially in similar rotating propellers as at this point power can be lost from the leading propeller unto the surface of the trailing propeller. And as the rotation continues in the warp zone FIG. 8C shows a weakened translation of power 128. As the blade tip of 30 meet the center medium mach of blade from 40. The extended warp zone 134 occurs in FIG. 8C and show the position of trailing propeller tip outside of the area of the overlapped propellers. FIG. 8B is similar to FIG. 4 and shows the ideal point for translation of power 128. The blades plan-form will be modified to work efficiently in this setup see FIG. 14. Simply the bi-propulsar could be designed that one propeller to rotate faster than the other but deliver relatively similar thrust. This would minimize blade interaction to once every other “x” times complete cycle. This can be accomplished by having varying airfoils or even number of blades see FIG. 28 between the leading and trailing propeller. Synchrophasing is most desired. As shown the rotation and position of blades interfere more than sound and vibration, but also are important in regard to maximum thrust. See also FIG. 23.

FIG. 9 is a schematic front elevation mainly depicting zones of variation of blade mach speed. See also FIG. 14. The further the distance away from the center of the propeller is the greater the distance that point has to travel to complete the same angle of rotation. Therefore the tip of the propeller is the fastest moving point on a propeller blade. In a bi-propulsar the warp zone as shown indicates an area of high thrust similar to the high mach area. The total area of high thrust is a greater percentage for a bi-propulsar than for a single propeller, a prior art contra-rotating propeller or even if the two propellers where separated and high mach area totaled.

The lower the angle of partial eclipse 100a is the greater the area of the warp zone. This angle is derived by drawing a line from the center of both range of motion circle. This line is drawn tangent TAN to the other opposing circle as shown.

FIGS. 10A-10C is a schematic front elevation as FIG. 9, with further illumination of the partial angle of eclipse. FIG. 10C angle of partial eclipse 100a is 120 degrees. As shown both circles are only touching not overlapped. This means any valid angle of overlap would have to be less than 120 degrees. FIG. 10B the lines cannot intersect they are parallel this angle is deduced as 0 degrees. Since the edge of both circles touch the center of each other this leaves no distance for an axle to have a diameter. Again this defines an extreme limit, where a valid angle must be greater than 0. FIG. 10A is the right partial eclipse, meaning the angle 100a is a right angle (90 degrees). At this point both tangents eclipse each other right at the tip of the warp zone and also where both lines converge. The right partial eclipse is turning point in bi-propulsar performance. Therefore angles less than 90 degrees or greater than 0 degrees are called a positive partial eclipse. Angles greater than 90 degrees and less than 120 are called a negative partial eclipse.

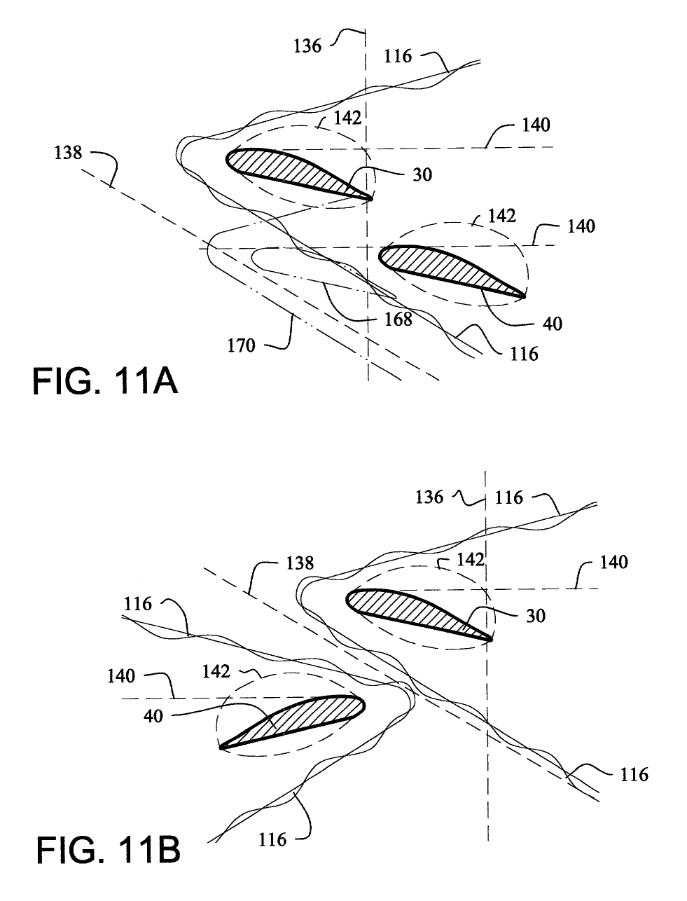

FIGS. 11A-11B is a cross-section of airfoils in warp zone, indicating airflow for both directions of rotation. A pressure zone 142 surrounds the airfoils of the propeller 30 and 40. The pressure zone is a result of airflow over the cambered surface of the airfoil. Air that flows over this layer of air does not produce lift but area of disturbance boundary 116 will affect the airflow over a trailing airfoil. FIG. 11A represents contra-rotating bi-propulsar blade 30 breaks the tension of trailing airfoil 40, hence reducing drag. However in position 168, the disturbance layer 116 of airfoil 30 reduces lift for 40. Fortunately this is rarely a problem, unlike contra rotating propeller, bi-propulsar blades are never completely inline with each other unless in the position shown in FIG. 8A. This makes temporary loss of lift only to partial areas of a blade. The leading propeller changes the direction and speed of incoming air 136 to approximately 138 for trailing propeller 40, which is closer to the direction of motion of airfoil and very desirable. The line of motion for the propeller is 140. FIG. 11B shows motion in a different direction as the disturbance boundaries 116 cross the air is compressed as both airfoils act against each other. This makes this option able to attain greater thrust in thin air. Its apparent that when blades interact they create attributes not possible if they where separated.

P factor is the uneven loading of a propeller induced by the relative incoming air being at an angle such as when aircraft is descending into a horizontal headwind. P-factor is negligible for propellers with relatively smaller diameter than a rotor, where p-factor is considerable. Also propellers are rigid in plane. P-factor is a factor in propeller vibrations this is virtually eliminated by increasing the number of blades the propeller has. Cyclic pitch can be considered as an optional solution also. The p-factor in a bi-propulsar will be uneven always as explained when propellers interact they affect each other. And as such it's desirable to have more than two propeller blades and also for the propellers themselves not to have too large a diameter. An efficient high-speed propeller is created not an energy efficient propeller you can't have both. The reduced propeller diameter is reduced drag.

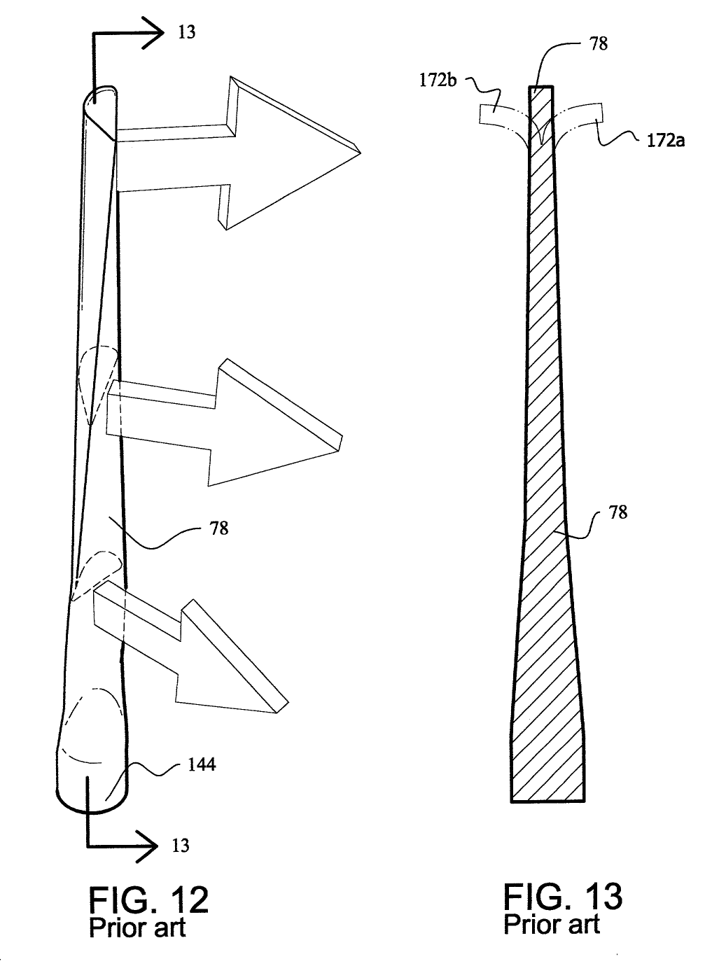

FIG. 12 is a side elevation of propeller blade 78, illustrating twist. The 3d arrows show direction of resultant thrust at different points along the blade. It's the tip of the blade that ultimately directs airflow and its also the tip with the highest mach. Slower air will also have a tendency to move up the twist to the airfoil region with the least angle of attack and hence resistance, this boundary layer eventually sheds at the tips as vortices (air circulating around itself). These vortices are responsible for propeller noise also.

The airfoil merges into a circular base 144 to facilitate rotation in the hub, for effecting change of pitch.

FIG. 13 is a cross-section of propeller blade, illustrating cahedral in the tip. Cahedral is a generic term, which includes both anhedral and dihedral. Anhedral occurs where the tip bends towards the high-pressure 172a side. And dihedral to the low-pressure side 172b.

Both are responsible to reduce the intensity of vortices shed at propeller tip and hence noise induced. The leading propeller at least should utilize cahedral since blades of trailing propeller will chop vortices.

FIG. 14 is a plan-form of propeller blade, discussing profile and effectiveness as a bi-propulsar. As shown FIG. 12 is a side view, this is viewing the blade from the direction of the incoming air. The shaded region is the typical form of an efficient propeller. The tip is rounded and blade narrows from the mean area of lift 150. This is where the airfoil is widest also where the airfoil type is determined. This should indicate that propellers don't have to be so wide or further than the mean area of lift, which is a function of blade speed and airfoil properties. As seen the low mach area narrows even when you take in account the blade has a twist. This would be efficient for a tractor propeller as the nacelle anyhow interferes with air close to the hub. As discussed in FIG. 13 cahedral will provide solution to blade noise and as such blade tip need not be rounded to reduce noise. A rounded tip represents loss of lifting surface. Alternate position lines 106 and 104; show a more tapered blade, where the low mach area has a wider base. This airfoil is more suited as a pusher. Position 104 is relatively parallel plan-form and is called an “H” plan-form and 106 is more tapered with an extremely wide base “V” plan-form.

FIG. 15 is a diagram showing by comparison height and width advantage over prior art. It must be noted that a bi-propulsar needs not be equivalent in area (most likely less than) as a single propeller to absorb the same total horsepower engine thrust, without allowing engine to over speed. But anyhow the comparison is a bi-propulsar 146 and single propeller 148 same total areas. The areas are similar but the circumference is larger for the bi-propulsar indicating more high mach area on the perimeter all with a reduced tip speed in comparison to 148 with a larger diameter if both propeller rotate at relatively same speed. This allows the bi-propulsar to rotate faster with higher thrust in the inner regions without exceeding the critical speed where loss of efficiency and noise results. Height H is the height of the bi-propulsar and width W is the width of the single propeller. The bi-propulsar has less height making excellent for ground and fuselage clearance. Two 4′6″ propellers could overlap on a pretty standard 42″ wide fuselage and the total area would be equivalent to a 6′2″ propeller again pretty standard general aviation figures. Even though the bi-propulsar is wider it still would be less than the width of the elevator or the separation point 56 FIG. 1. Allowing folding wings option. Finally the high thrust area is greater than if propeller where separate.

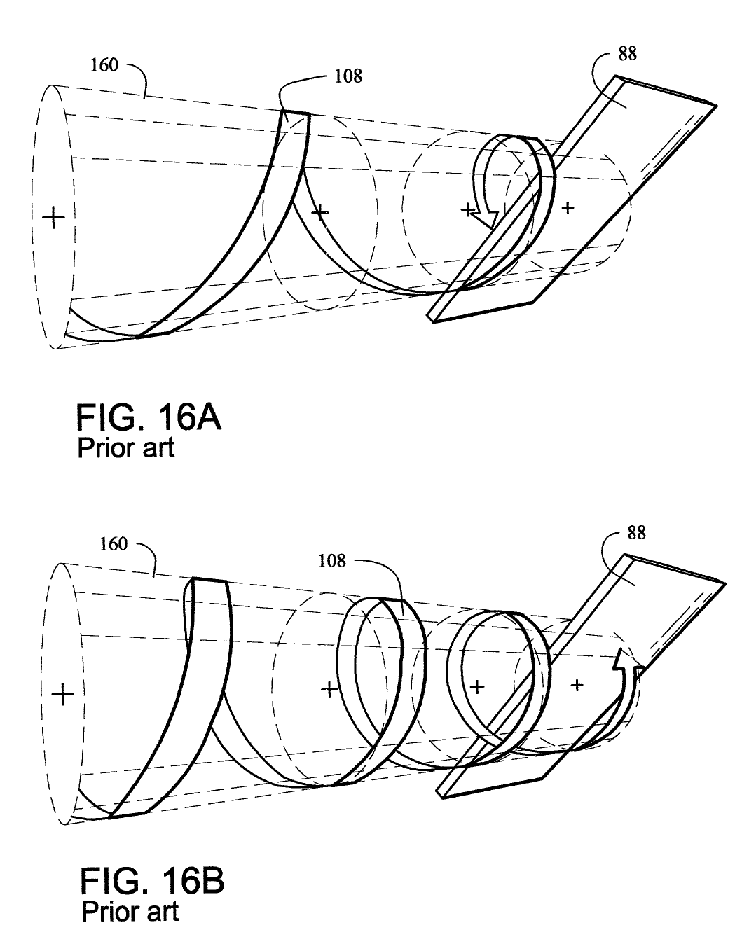

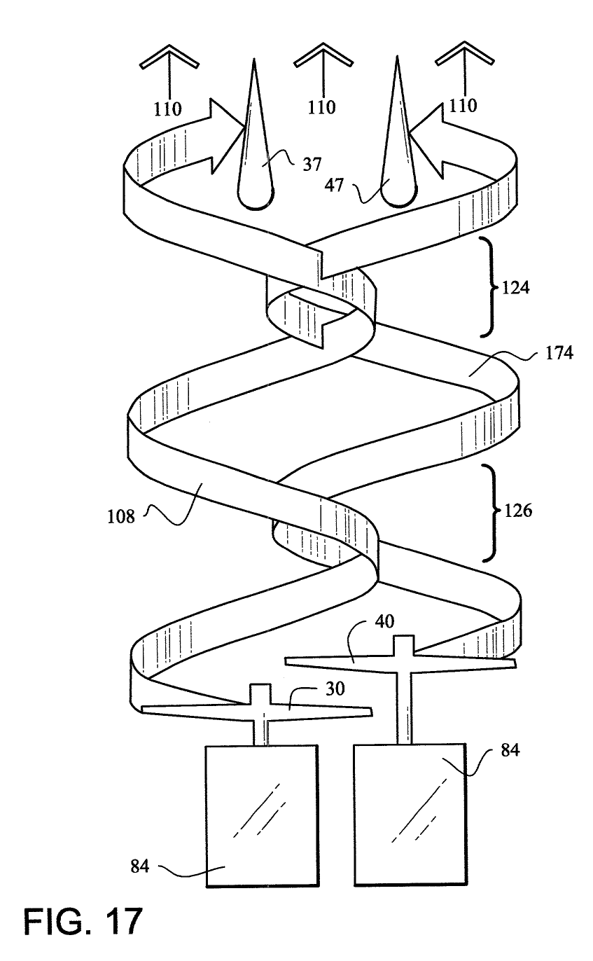

FIGS. 16A-16B is a perspective of helical contrail, showing relation between frequency and slipstream direction. 16A shows 2 turns and FIG. 16B shows 3.5 turns. The increase in the amount of turns in the helix within the contrail cylinder 160 is referred to as the frequency and is a direct result of change of speed of the propeller. FIG. 16A shows the slipstream 108 acting on the left side of control surface 88 as the speed changes as shown in FIG. 16B slipstream 108 is acting now on right side of control surface 88. In reality the rudder of an aircraft is usually canted not in the direction of the flight axis of the aircraft but instead in the direction of propeller induced airflow at cruise. This means in non-powered high speeds such as descending from altitude significant rudder compensation is needed to control yaw. This is also the case when operating above and below cruise speed. This makes flight so much more complex especially at a time when it could be an emergency non-powered landing.

It should be understood that even though a slipstream is shown there is relatively higher pressure within the contrail cylinder than the surrounding air. There is lower pressure in the core always.

FIG. 17 is a plan view of contra-rotating contrails of bi-propulsar and twin rudder. The left rudder 37 and right rudder 47 always remain parallel and both work in sync, it's desired for both to be inline with the flight axis of the aircraft. It's desired that the control surfaces, rudder and elevator not be to any side of a contrail but relatively centered or completely out of the way as with a “hammer” configuration FIG. 2. If the air pressure is higher on one side of any control surface it will understandably cause deflection to the low-pressure side. A twin rudder will reduce the effect of slipstream even if one engine is running. Tracing the path of one slipstream 108 it only hits the sides of rudder 37, that lessens the effect of a slipstream by 50% since rudder 47 is unaffected by slipstream. The effect is even less when you consider that 110 the free stream air is always constant on all 3 positions around rudders as shown. The faster the aircraft travels will be the faster the incoming free stream air and the less the effect of slipstream will be noticeable. With both propellers working its evident that slipstream 174 is acting in contrast to 108 and act on both rudders in opposing direction assuming both propellers are producing similar thrust then there will be no need for rudder compensation. At point 124 the streams cross and this represents a loss of rotational energy not linear energy. Energy will still be propelled backward in pulses much like a contra-rotating propeller of prior art. At 126 both main streams miss each other. Speed change in the propeller controls the frequency of both contrails interacting or not (see FIGS. 16A-16B), controls also the direction, variation and resultant forces exerted on the rudders. 84 introduce the engines, which are similar but need not be exactly identical in weight, power and size. Its understandable that one engine will spin in opposing direction for contra-rotating bi-propulsar. 30 and 40 are the propellers. When a propeller spins there is an equal and opposite reaction in the other direction, this rolling motion by the engine is referred to as torque. It is acceptable policy to counter torque by having propellers spin in opposite directions as described above.

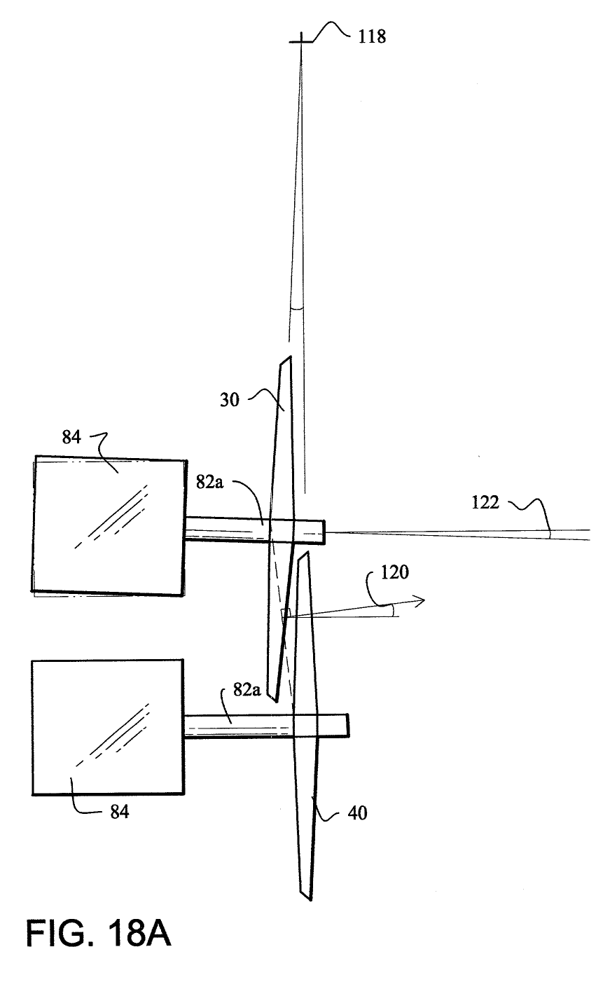

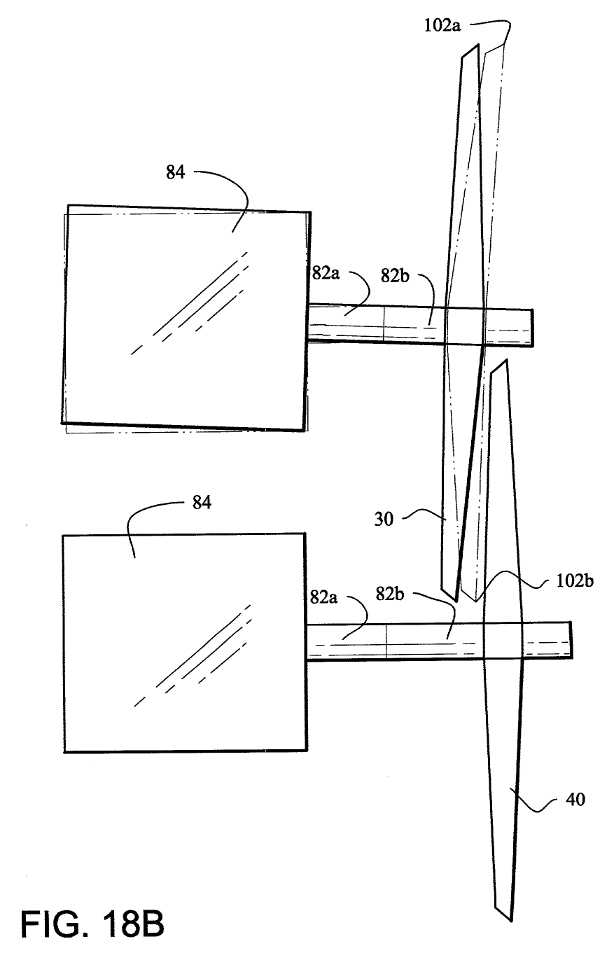

FIGS. 18A-18B is a plan showing canting of leading propeller towards trailing propeller, and anhedral coning of blade. FIG. 18A shows propeller 30 canted into the direction of propeller 40 converging at point 118. FIG. 18B shows anhedral coning of propeller 30 that was previously canted. The canting of the propeller can be achieved by rotating the engine 84 of the leading propeller, or by change of direction of the propeller shaft 82a by adding an extension 82b. Assuming both propellers create the same thrust, taking a line from the similar point on each propeller and then drawing a right angle. A provisional angle of resultant thrust can be determined and understandably the further the propellers are apart the more the resultant angle 120 would increase. It's not desired for the cant to the propellers 122 to be too great or is it even necessary to be as large an angle as to counter the side drift resultant force 120, which is the angle with which resultant force vary from the line of direction of the aircraft flying straight ahead. Understandable that for the aircraft to travel ahead in this line there must be an equal and opposing force in the other direction. FIG. 18B shows that the blades can be coned inwards to point 102a basically in plane with the trailing propeller tips. This would afford blade tip 102b to be relatively parallel with trailing propeller 40, blade tip. The angle of the cone blade would be sufficient along with cant to make resultant thrust vector once again 0 degrees. Blades are coned towards high pressure and such I refer to the following as anhedral coning. A canted propeller will not pose a problem for a twin rudder system as explained in FIG. 17. It should also be understood that the engines could be moderately staggered (without adverse affect to weight and balance) in opposite fashion to the propellers to also modify the arm through which force is transmitted to airframe, which ultimately moves the entire aircraft.

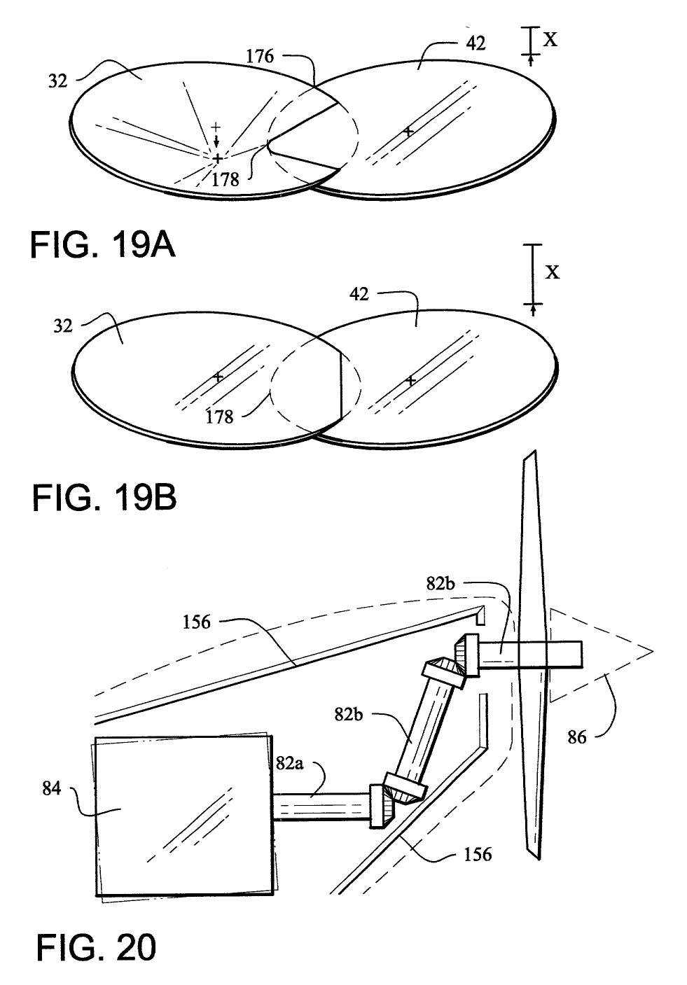

FIGS. 19A-19B is a perspective showing simplified discs and the benefit of coning. FIG. 19A is a coned surface 32 (range of motion disc), intersecting flat disc 42 (range of motion disc). Point 176 is the furthest distance discs are apart. In FIG. 19B point 178 is farthest distance discs are apart. Considering that both discs are at the same relative angle to each other and diameter. The two flat discs will have to move a greater distance forward “x”, so that they do not strike each other in a complete range of motion, or in this case interpenetrate.

FIG. 20 is a side elevation of a propeller in a bi-propulsar, providing miscellaneous options. Engine 84 shows alternate position for engine not limited to plan view also method for changing height of propeller allowing a more aerodynamic cowl. Shows method of transmitting power up to a different level using gears at end of propeller shafts extensions 82b. The shaft is usually subjected to high stress and is preferably constructed of carbon fiber. The spinner 86 allows for more aerodynamics in non-powered flight. Cantilever trusses 156 structurally support nacelle and propeller shaft and are connected to the fuselage framework. Also desired is that each nacelle contain a remote controlled fire extinguisher, this is of even more advantage to military versions. A propeller shaft brake is also desired. Where the braking system could be hydraulic engaging brake pads to propeller shaft or attached disc. The brake would allow one propeller to stop rotating or even wind milling allowing safe rapid entrance and exit from aircraft on the side with inactive engine, also this reduces noise if desired for stealth mode. See FIG. 28 for related positioning. It should be understood the braking and fire extinguisher system could be applied without the change of height of propeller. All are valid individual options.

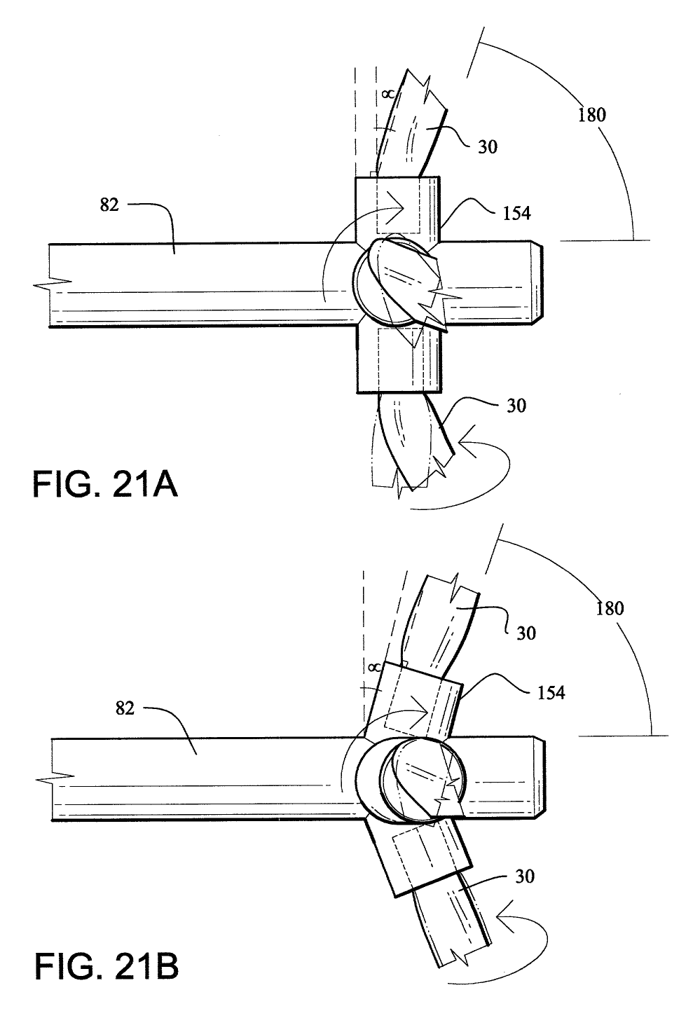

FIGS. 21A-21B is a side elevation showing methods for effecting anhedral coning in propeller. For clarity the angles have been exaggerated. The subtle angle with which coning is created to match, would not interfere with the adaptation of prior art method for effecting variable pitch and constant speed propellers. FIG. 21A shows blade 30 being bent at an angle, this simple option allows the coning angle 180 of the propellers to change dynamically with the angle of pitch as the propeller rotates within the hub 154. See FIG. 12 where the hub is prior art. FIG. 21B shows the hub instead angled; this option allows change of pitch of the propeller without affecting the blades coning angle. It must be understood that a fixed pitch propeller can also be used for a bi-propulsar.

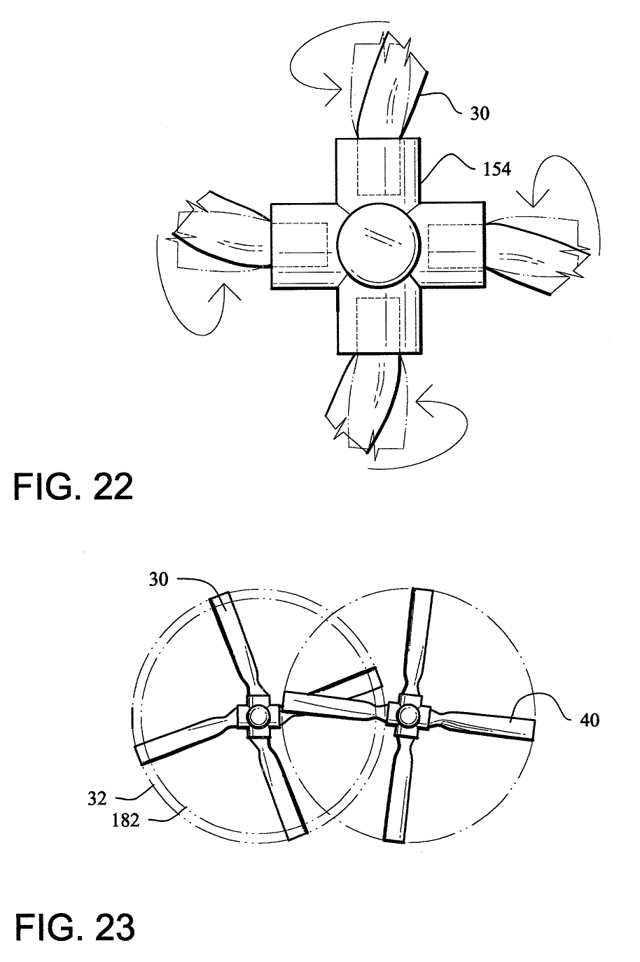

FIG. 22 is a front elevation showing swept propeller blades for controllable pitch and coning angle propeller. As shown in FIG. 21A this is the front elevation showing that as the angle of coning changes so does the angle of the swept blades. This happens automatically due to the bend in the propeller blade 30 as shown. The circular base embedded in hub 154 allows rotation.

FIG. 23 is a front elevation of bi-propulsar, further discussing swept propeller blade. As shown the diameter also reduces 182 as the propeller cones from 32. Full swept blades 30 also show that even though FIG. 8B is the same position as this figure that blade 40 can no longer ever completely overlap 30. Savings in efficiency and noise level is expected. A swept and anhedral coned propeller also produces less drag as in FIG. 18A. Where a sloped surface produces less drag at higher speed than a flat surface to direction of motion, this is the same principle adapted by high-speed wings as shown in “hammer” configuration. It must be understood that a fixed pitch propeller can also have a swept propeller blade, additionally that both propellers don't have to be exactly equal in diameter. And that the point of bend can be higher up the blade, as noise level is usually associated with the high mach area.

FIG. 24 is a perspective of contrail cylinder for contra-rotating bi-propulsar. Representing range of motion 32 and 42 highlighting the staggered position of the propellers. Contrail cylinder 160 as introduced in FIG. 16A containing spiraling air, basically diagram shows flanging of the outgoing air contrail. Both contrails interact and there is a loss of rotational energy and dispersion this represents a stable and more uniform contrail than a single propeller. Zone 1 represents loss of rotational energy. Zone 2 represents air projected back in pulses with rotational energy negligible. Actual form of contrail depends on the frequency of the spiral interaction as explained in FIG. 17. Understandable that both engines will have to rotate opposite direction to each other and the twist of the airfoils will also be opposite.

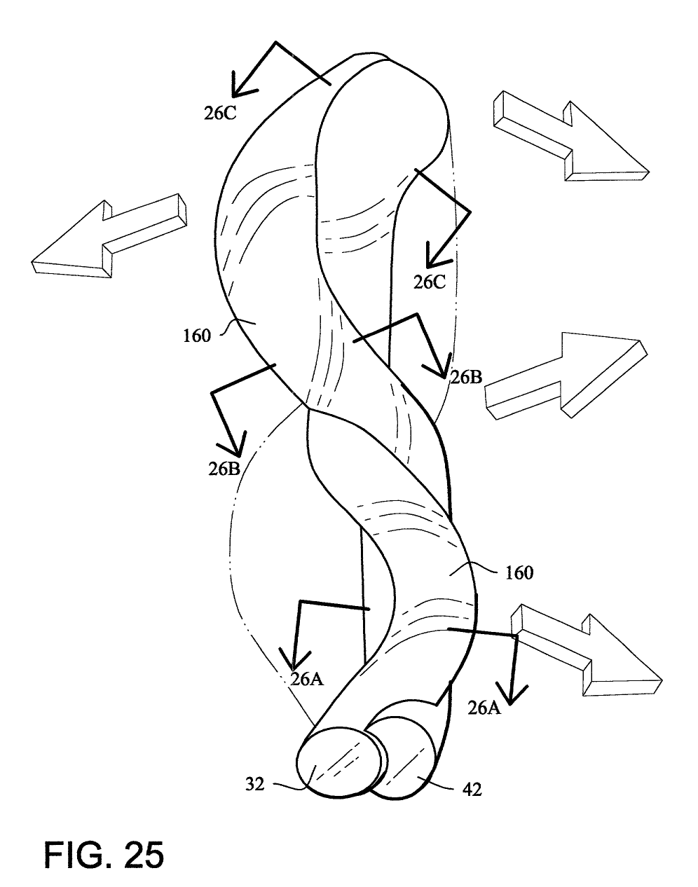

FIG. 25 is a perspective of contrail cylinder for similar-rotating bi-propulsar. Representing range of motion 32 and 42 highlighting the staggered position of the propellers. Contrail cylinder 160 as introduced in FIG. 16A containing spiraling air, basically diagram shows twisting of the outgoing air contrail. Both contrails interact and there is a rapid exponential increase of rotational energy. Both cylindrical contrails attempt to merge and as a result the entire body of twisting air itself would turn in a helix type pattern itself if conditions were right. However the “twister” can take on any twisting form according to the frequency of interaction of spiraling air as described in FIG. 17. 3d arrows show potential directional instability. Understandable that both engines will have to rotate in the same direction and the twist of the airfoils will also be in the same direction.

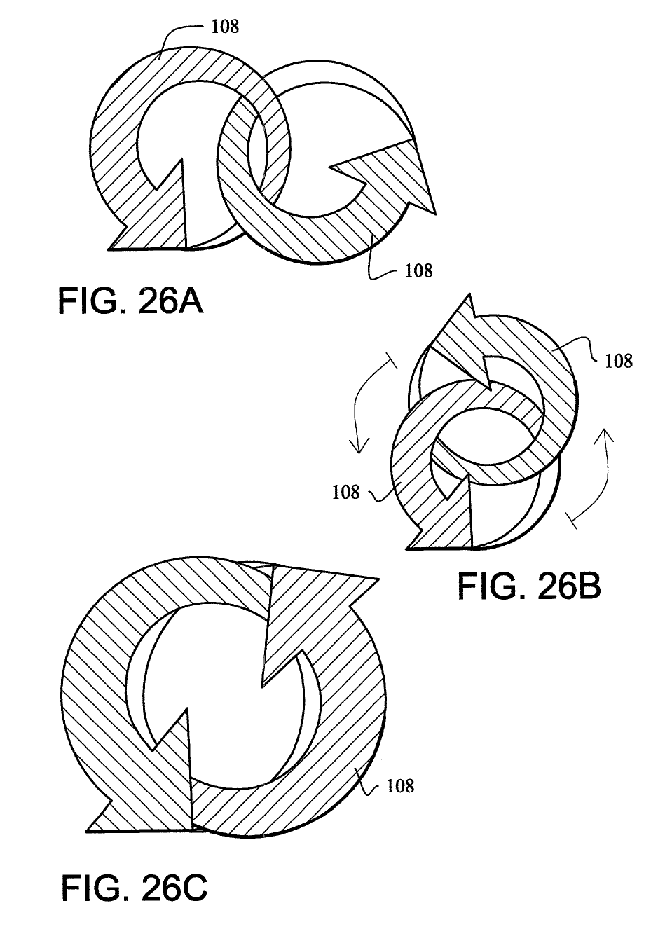

FIGS. 26A-26C is a cross-sections series of the “twister” as introduced in FIG. 23. FIG. 26B shows both contrails as the increase in speed and overlaps more and constrict. Eventually 26C shows dilation and loss of rotational energy and directional instability.

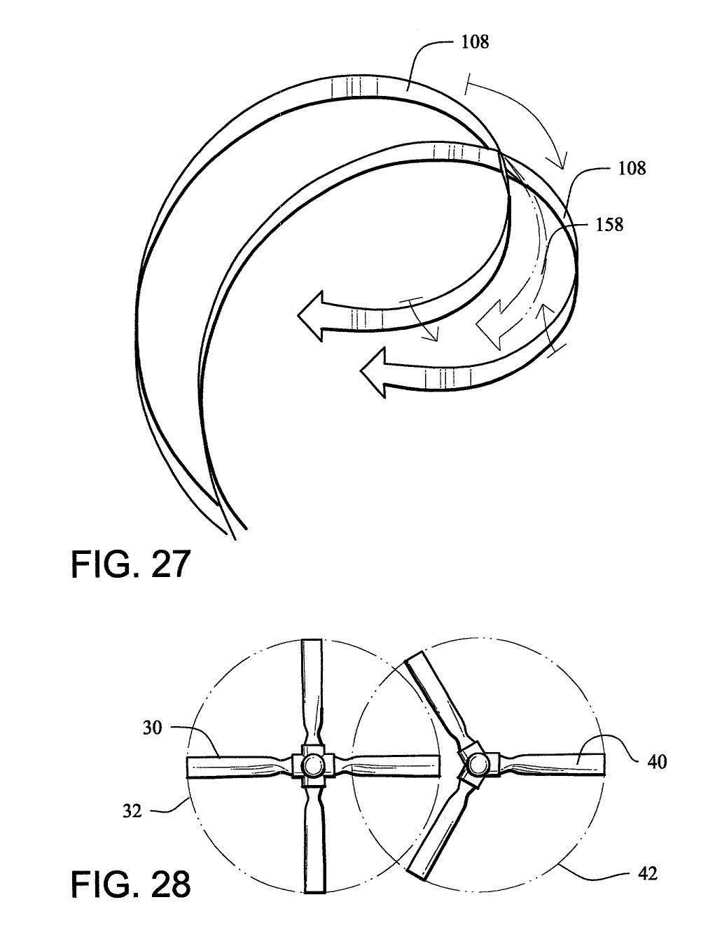

FIG. 27 is a perspective of helical spirals causing a twisting motion. Similar rotating contrails 108 at intersection they move according to arrows due to resultant force 158.

FIG. 28 is a front elevation of bi-propulsar showing leading propeller not interacting with static trailing propeller. Trailing propeller 40 is a 3 bladed propeller allowing with the use of synchronized position and adapted rotor brake as introduced in FIG. 20 to hold propeller 40 static, so that propeller 30 which can also be 3 blade can be run without interacting with the blades of propeller 40. This gives the ability to get maximum thrust from propeller 30 when 40 is inactive reducing noise associated by interacting blade by vortices shed from leading propeller into trailing propeller. Simply for stealth or single engine operation propeller 40 would be chosen over 30 for single engine operation, as vortices are not projected forward.

Modeling example of the propulsion system where built tested and witnessed and appropriate deductions where made and the preferred embodiments chosen accordingly, however it is understandable by those skilled in the art that other embodiments are possible. Where different combinations justify different advantages as disclosed above.

What I claim as my invention is:

1. A pusher aircraft propulsion system, comprising:
(a) A fuselage.
(b) A pair of engines attached to said fuselage. Thereof are substantially symmetrically located on the left and right side of said fuselage, respectively. Whereby weight, balance and aerodynamics are simplified.
(c) A propeller is attached to each of said engines on the left and right. Said propellers are staggered apart and overlap substantially with appropriate tolerance. As a means for not striking each other in full range of motion or the propeller shafts that drive the propeller.

2. The propellers of claim 1 in which thereof twist are opposite direction to each other and said engines both rotate in opposite directions to each other. Whereby torque forces substantially oppose and nullify each other and the contrail is most stable from the loss of rotational energy and slipstream related problems. Also whereby the warp zone allows reduced drag and increases efficiency at lower speed, than if they where separated.

3. The propellers of claim 1 in which thereof twist are similar direction to each other and said engines both rotate in similar directions to each other. Whereby the higher outgoing air velocity “twister” combined with the compression of air in the warp zone provides more thrust for relative speed, than if they where separated.

4. The propellers of claim 1, in which the leading propeller is canted into the trailing propeller. Thereof so disposed eliminates side drift resultant force. Whereby both propellers can produce substantially similar thrust, without resultant force being out of line with the direction of aircraft.

5. The leading propeller of claim 4, in which thereof is coned anhedral. Whereby propellers can be offset with reduced more uniform distance, as a means of improving performance. Whereby leading propeller need for canting is reduced. In regards to allowing resultant force to be inline with direction of aircraft, as heretofore described.
